(19) United States
(12) Patent Application Publication
(10) Pub. No.: US 2002/0043957 A1
(43) Pub. Date: Apr. 18, 2002

(54) Device with rechargeable battery

(76) Inventor: Erich Krainer, St. Veit an der Glan (AT)

Correspondence Address: US Philips Corporation, 580 White Plains Road, Tarrytown, NY, 10591, US

(21) Appl. No.: 09/548,305

(22) Filed: Apr. 12, 2000

(30) Foreign Application Priority Data
Apr. 14, 1999 (EP) 99890125.0

(51) Int. Cl. H02J 7/00

(52) U.S. Cl. 320/108

(57) ABSTRACT

In a device (1) with a housing (2) and a rechargeable battery (5) accommodated in the housing (2), the rechargeable battery (5) lies at least with a portion (28) thereof inside a secondary coil (9) of a transformer (10) of charging means (8), while preferably magnetic field shielding means (29) are provided which are arranged parallel to the rechargeable battery (5), which lie with a portion (30) thereof inside the secondary coil (9), and by means of which the magnetic field permeating the secondary coil (9) can be concentrated and thus be kept away from the rechargeable battery (5).

The invention relates to a device as defined in the preamble of claim 1.

Such a device, constructed as an electrically driven toothbrush, was marketed in various embodiments by applicant and is accordingly known. Reference may also be made to the two patent documents WO 97/24.079 A1 and WO 98/26.729 A1 in relation with such a known device. It is true that the charging means and a secondary coil of a transformer accommodated in the device are not disclosed in these two patent documents, because this is not necessary therein, but this is not essential in the present case because such charging means and such a secondary coil are generally known to those skilled in the art. The rechargeable battery and the secondary coil in the known device are situated at a certain distance from one another in a direction parallel to the coil axis of the secondary coil, which has the result that the dimension of the known device in this direction, i.e. the longitudinal direction of the known toothbrush, is comparatively great, which results in a device with a comparatively long housing in the direction mentioned above. In many applications, indeed, this does not constitute a problem at all. It was found, however, that there are also applications where a shorter dimension of a device in the above direction is desirable or effective. This desire cannot be fulfilled in a simple manner in the known device, an important reason for this being that the rechargeable battery and the secondary coil are arranged at a distance from one another as seen in the direction mentioned above.

The invention has for its object to eliminate the problems mentioned above and to achieve in a simple manner and by simple means that the limitations described above are no longer present.

To achieve this object in a device as defined in the preamble of claim 1, the characteristic as defined in the characterizing part of claim 1 is additionally provided.

The measures according to the invention achieve in a simple manner that a device according to the invention can be realized with a smaller dimension, i.e. a comparatively small dimension in a direction parallel to the coil axis of the secondary coil, which is formed as a hollow cylinder, in comparison with known constructions.

The construction of a device according to the invention may be such that the rechargeable battery extends only into a portion of the secondary coil formed as a hollow cylinder. It was found to be particularly advantageous, however, when in such a device the measures in accordance with claim 2 are also provided, because an optimized utilization of space is achieved in this manner.

It was found to be also particularly advantageous in a device according to the invention when the measures in accordance with claim 3 are additionally provided. It is achieved thereby that practically no eddy current losses occur in the battery housing of the rechargeable battery, and accordingly practically no heating of the rechargeable battery takes place, which provides the advantage that no problems caused by an overheated battery can arise in such a device according to the invention. It is furthermore achieved thereby that a higher charging current can be used than in known constructions, and that nevertheless a lower energy consumption at the primary side of the transformer can suffice as compared with known constructions.

It was found to be particularly advantageous for the realization of the magnetic field shielding means in a device according to the invention when in addition the measures in accordance with claim 4 are provided, because a very good concentration of the magnetic field is possible with such a ferrite part, and accordingly a very good shielding of the magnetic field from the rechargeable battery is achieved.

It was also found to be highly advantageous in a device according to the invention when in addition the measures in accordance with claims 6, 7 or 8 are provided, because these embodiments have the particular advantage of being inexpensive.

It is also very advantageous in a device according to the invention when in addition the measures in accordance with claim 9 are provided, because a very good shielding of the magnetic field from the rechargeable battery is safeguarded thereby.

The measures according to the invention were found to be particularly advantageous in a device according to the invention as defined in claim 10.

The above and further aspects of the invention will become apparent from the following description of a number of embodiments and be clarified with reference to these embodiments.

The invention will now be described in more detail with reference to two embodiments shown in the drawings and one further embodiment which is not shown; however, the invention is by no means limited to these three embodiments.

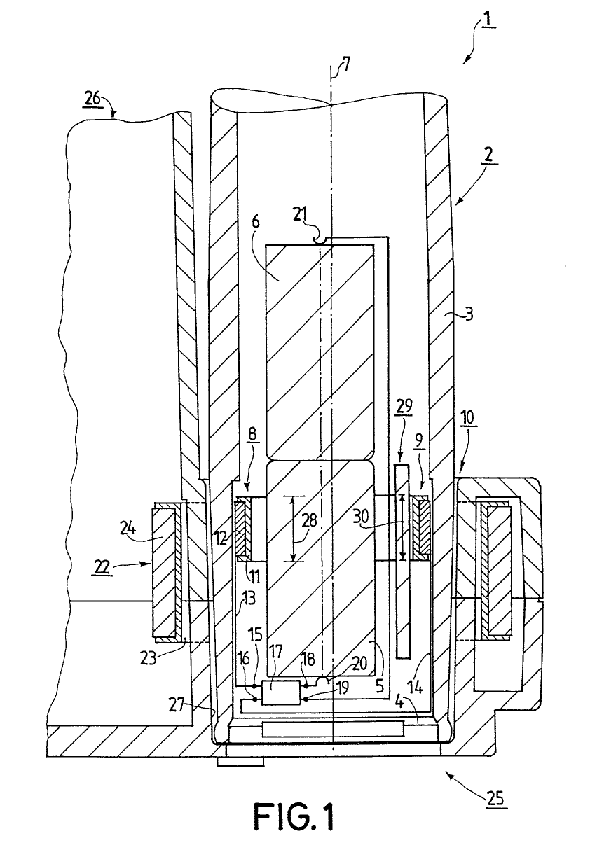

FIG. 1 shows in cross-section part of a device according to the invention in a first embodiment of the invention, where the magnetic field shielding means comprise a ferrite part.

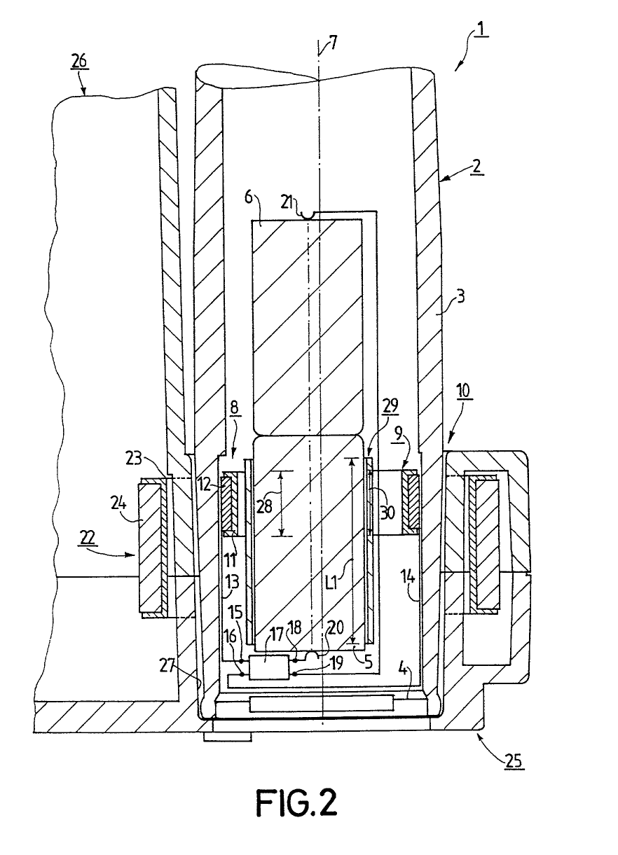

FIG. 2 shows in a similar manner as FIG. 1 a device according to the invention in a second embodiment of the invention, where the magnetic field shielding means comprise a hollow cylindrical metal part.

FIG. 1 shows part of a device 1, which here is an electrically driven toothbrush, such as it is known, for example, from the two patent documents WO 97/24079 A1 and W098/26729 A1.

The device 1 has a housing 2. The housing 2 substantially consists of a sleeve part 3 and a cover part 4 which is detachably connected to the sleeve part 3. The cover part 4 is detachable from the sleeve part 3 so as to enable access to the interior of the housing, for example for the purpose of exchanging rechargeable batteries. Indeed, a first rechargeable battery 5 and a second rechargeable battery 6 are accommodated in the housing 2. The two rechargeable batteries 5 and 6 are elongate in shape and of circular-cylindrical shape in this case. The two rechargeable batteries 5 and 6 are arranged one behind the other in a longitudinal direction of the housing as indicated with a dash-dot line 7, such that the two rechargeable batteries 5 and 6 are connected with electrical conduction to one another by means of battery contacts which make contact with one another (not shown).

Charging means 8 are accommodated in the housing 2. The charging means 8 are constructed for charging the two rechargeable batteries 5 and 6. The construction of the charging means 8 has nothing out of the ordinary and has been known for a longer period from known devices, for example from toothbrushes marketed by applicant. For this reason the charging means 8 are described briefly only.

The charging means 8 comprise a secondary coil 9 of hollow cylindrical shape belonging to a transformer 10, which is often referred to as air-core transformer. The secondary coil 9 here consists of a carrier 11 for a winding of the secondary coil 9 and a winding 12 consisting of coil wire. A first coil wire end 13 and a second coil wire end 14 of the winding 12 are led to two inputs 15 and 16 of a charging circuit 17, which also forms part of the charging means 8. A DC voltage can be generated by means of the charging circuit 17 from an AC voltage supplied to one of the inputs 15 and 16 of the secondary coil 9, which DC voltage appears at two outputs 18 and 19 of the charging circuit 17 and can be conducted from the two outputs 18 and 19 to two supply contacts 20 and 21, of which the first supply contact 20 is in electrical contact with a battery connection contact (not shown) of the first rechargeable battery 5 and the second supply contact 21 is in electrical contact with a battery connection contact (not shown) of the second rechargeable battery 6. The DC voltage generated by the charging circuit 17 for charging the two rechargeable batteries 5 and 6 can thus be supplied to these two rechargeable batteries 5 and 6.

The secondary coil 9 forms part of a transformer 10, as was noted above. The transformer 10 has a primary coil 22 which also substantially has the shape of a hollow cylinder and which consists of a carrier 23 for a winding of the primary coil 22 and of a winding 24 of coil wire. The coil wire of the winding 24 is connected by its two ends (not shown) to electrical means which are or can be connected to a mains supply.

The primary coil 22 of the transformer 10 is accommodated in a charging station 25 for the device 1. The charging station 25 has a housing 26 in which a cup-shaped chamber 27 is provided. The device 1 is insertable with its housing 2 in the longitudinal housing direction 7 into this chamber 27, such that the device 1 after being fully inserted into the charging station 25 occupies the position relative to the charging station 25 as pictured in FIG. 1. In this relative position of the device 1 with respect to the charging station 25, the secondary coil 9 of the transformer 10 lies inside the primary coil 22 of the transformer 10, whereby a good magnetic coupling is provided.

The device 1 is advantageously so constructed that the first rechargeable battery 5 lies with a portion 28 thereof inside the secondary coil 9. The portion 28 of the first rechargeable battery 5 is indicated with a double arrow in FIG. 1. Shapes and dimensions of the device 1 are so arranged here that the first rechargeable battery 5 projects through the full length of the secondary coil 9. It is advantageously achieved by means of this arrangement that the dimension of the device 1 in the longitudinal direction of the housing 7 is smaller than in known devices of this kind.

Magnetic field shielding means 29 are additionally provided in the device 1. The magnetic field shielding means 29 are arranged so as to extend parallel to the longitudinal direction of the first rechargeable battery 5. Furthermore, the magnetic field shielding means 29 lie with a portion 30 thereof, again indicated with a double arrow in FIG. 1, within the secondary coil 9. The magnetic field shielding means 29 are formed by a single ferrite part in the present case which is present next to the first rechargeable battery 5 and which completely projects through the secondary coil 9. The ferrite part constituting the magnetic field shielding means 29 here takes the form of a cylindrical rod which is passed through the secondary coil 9. The magnetic field permeating the secondary coil 9 can be concentrated by the magnetic field shielding means 29, so that the magnetic field density in the regions of the free ends of the magnetic field shielding means 29 is substantially higher than in the regions of the two rechargeable batteries 5 and 6, with the result that the magnetic field can be kept away from the first rechargeable battery 5 and also from the second rechargeable battery 6 by the magnetic field shielding means 29. The generation of any current losses in the battery housing of the first rechargeable battery 5 and also in the battery housing of the second rechargeable battery 6 is thus prevented in a simple manner, so that also the problems and/or disadvantages which may arise from such eddy current losses have been eliminated.

FIG. 2 shows a further device 1 in which now the magnetic field shielding means 29 are formed by a short-circuiting winding of hollow cylindrical shape which surrounds the first rechargeable battery in the region of a portion L1 of its longitudinal dimension and which projects through the secondary coil 9. In the device 1 of FIG. 2, the short-circuiting winding forming the magnetic field shielding means 29 is formed in a simple manner by a hollow cylindrical metal part, which is preferably formed by a deep-drawn tube. The tube is made from copper. It may alternatively be made from aluminum. A concentration of the magnetic field is achieved also by means of the magnetic field shielding means 29 in the form of a tube, so that eddy current losses in the battery housings of the two dischargeable batteries 5 and 6 are minimized, and accordingly the disadvantages which may arise from such eddy current losses are prevented.

In a further device 1 according to the invention, which is not separately shown in a drawing, the magnetic field shielding means 29 comprise not only a hollow cylindrical short-circuiting winding but also a ferrite part, in which case the hollow cylindrical short-circuiting winding surrounds a rechargeable battery 5 at least in the region of a portion L1 of its longitudinal dimension, while the ferrite part is present next to this rechargeable battery 5. The advantages described above are safeguarded also in this device 1 according to the invention which is not shown.

The invention is not limited to the three embodiments described above. It is also possible for only a single battery to be present in a device according to the invention. Neither is it necessary for batteries used to have a circular-cylindrical shape, but instead batteries of cylindrical shape may alternatively be used in which the base surface of the cylinder is formed by a rectangle. Obviously, the invention is not only applicable to electrically driven toothbrushes but also to other devices according to the invention.

1. A device (1)
with a housing (2),
with a rechargeable battery (5) accommodated in the housing (2), and with charging means (8) which are arranged in the housing (2), which are designed for charging the battery (5), and which comprise a substantially hollow cylindrical secondary coil (9) of a transformer (10) whose primary coil (22) is arranged in a charging station (25) for the device (1), characterized in that the rechargeable battery (5) lies at least with a portion (28) thereof inside the secondary coil (9).

2. A device (1) as claimed in claim 1, characterized in that the rechargeable battery (5) has a substantially elongate and preferably cylindrical shape and projects fully through the secondary coil (9).

3. A device (1) as claimed in claim 2, characterized in that magnetic field shielding means (29) are provided which are arranged substantially parallel to the longitudinal direction of the rechargeable battery (5), which lie at least with a portion (30) thereof inside the secondary coil (9), and by means of which the magnetic field permeating the secondary coil (9) can be concentrated and thus be kept away from the rechargeable battery (5).

4. A device (1) as claimed in claim 3, characterized in that the magnetic field shielding means (29) comprise a ferrite part which is present next to the rechargeable battery (5) and which projects through the full length of the secondary coil (9).

5. A device (1) as claimed in claim 4, characterized in that the ferrite part forming the magnetic field shielding means (29) has the form of a cylindrical rod which projects through the full length of the secondary coil (9).

6. A device (1) as claimed in claim 3, characterized in that the magnetic field shielding means (29) comprise a short-circuiting winding in the form of a hollow cylinder which surrounds the rechargeable battery (5) at least in the region of a portion (L1) of its longitudinal dimension and which projects through the full length of the secondary coil (9).

7. A device (1) as claimed in claim 6, characterized in that the short-circuiting winding forming the magnetic field shielding means (29) is formed by a hollow cylindrical metal part.

8. A device (1) as claimed in claim 7, characterized in that the metal part is formed by a deep-drawn tube.

9. A device (1) as claimed in claim 6, characterized in that the magnetic field shielding means (29) comprise in addition to the hollow cylindrical short-circuiting winding a ferrite part which is arranged next to the rechargeable battery and which projects through the full length of the secondary coil.

10. A device (1) as claimed in claim 1, characterized in that the device (1) is constructed as an electrically operable toothbrush.
